(19) United States
(12) Patent Application Publication
(10) Pub. No.: US 2025/0286323 A1
(43) Pub. Date: Sep. 11, 2025

(54) Connector Assembly and Board-End Connector Thereof

(71) Applicant: HARUMOTO TECHNOLOGY (SHEN ZHEN) CO., LTD., Shenzhen (CN)

(72) Inventors: CHING-CHUAN KUNG, Taipei (TW); CHING-HSUAN YEN, New Taipei (TW)

(21) Appl. No.: 19/073,014

(22) Filed: Mar. 7, 2025

(30) Foreign Application Priority Data
Mar. 8, 2024 (CN) 202410266313.5

(51) Int. Cl. H01R 13/6581; H01R 12/71; H01R 13/02

(52) U.S. Cl. CPC H01R 13/6581; H01R 12/716; H01R 13/02

(57) ABSTRACT

A connector assembly and board-end connector thereof, wherein the board-end connector comprises multiple terminal modules, each of which comprises a signal terminal and a metal shielding cover. The metal shielding cover provides a shielding environment for the signal terminal to reduce the level of crosstalk interference when the signal terminal transmits high-speed signals.

### CROSS-REFERENCE TO RELATED APPLICATIONS

This application claims the priority of China Patent Application No. 202410266313.5 filed on Mar. 8, 2024, in the State Intellectual Property Office of China, the disclosure of which is incorporated herein by reference.

### BACKGROUND OF THE INVENTION

### Field of the Invention

This application relates to a connector assembly and board-end connector thereof. More specifically, it refers to a connector assembly and board-end connector that can reduce crosstalk interference on signal terminals when transmitting high-speed signals.

### Descriptions of the Related Art

Connector assemblies are widely used in various electronic devices. In recent years, connector assemblies have been designed to work with circuit boards. Generally, a connector assembly comprises a board-end connector and a mating component. The board-end connector comprises signal terminals, where the signal terminals can join a circuit board and mate with the board-end connector, thereby providing electrical signal transmission within electronic devices.

However, currently, signal terminals of board-end connectors are prone to crosstalk interference when transmitting high-speed signals, which causes interference and attenuation of the high-speed signal transmission. Therefore, how to suppress crosstalk interference so that the signal terminals of the board-end connector can achieve high-speed signal transmission is a problem that needs to be solved by those skilled in the art.

### SUMMARY OF THE INVENTION

In view of the drawbacks of the prior art mentioned above, the present application provides a board-end connector, the board-end connector comprising: a connector insulating core, the connector insulating core comprising a major mating side, a major non-mating side, a major joining side, a major non-joining side, a connector insulating core mating space, and a connector insulating core joining space, wherein the major non-mating side and the major mating side are substantially different, and the major non-joining side and the major joining side are substantially different; a first major terminal module, the first major terminal module comprising a first major signal terminal, a first major metal shielding cover, and a first major signal terminal insulating core, the first major signal terminal comprising a first major signal terminal mating structure and a first major signal terminal joining structure, the first major metal shielding cover comprising a first major metal shielding cover mating shielding structure, a first major metal shielding cover joining shielding structure, a first major metal shielding cover mating passage, and a first major metal shielding cover joining passage, the first major signal terminal insulating core being mated with the first major signal terminal, and the first major terminal module being configured in the connector insulating core, such that the first major signal terminal mating structure is located in the connector insulating core mating space and the first major signal terminal joining structure is located in the connector insulating core joining space, the first major metal shielding cover being mated with the first major signal terminal insulating core, such that the first major metal shielding cover mating passage is in continuity with the connector insulating core mating space, allowing the first major signal terminal mating structure to be mated via the first major metal shielding cover mating passage on the major mating side, and the first major metal shielding cover joining passage is in continuity with the connector insulating core joining space, allowing the first major signal terminal joining structure to be joined via the first major metal shielding cover joining passage on the major joining side, wherein the first major metal shielding cover mating shielding structure extends on the major non-mating side, and the first major metal shielding cover joining shielding structure extends on the major non-joining side; a second major terminal module, the second major terminal module comprising a second major signal terminal, a second major metal shielding cover, and a second major signal terminal insulating core, the second major signal terminal comprising a second major signal terminal mating structure and a second major signal terminal joining structure, the second major metal shielding cover comprising a second major metal shielding cover mating shielding structure, a second major metal shielding cover joining shielding structure, a second major metal shielding cover mating passage, and a second major metal shielding cover joining passage, the second major signal terminal insulating core being mated with the second major signal terminal, and the second major terminal module being configured in the connector insulating core, such that the second major signal terminal mating structure is located in the connector insulating core mating space and the second major signal terminal joining structure is located in the connector insulating core joining space, the second major metal shielding cover being mated with the second major signal terminal insulating core, such that the second major metal shielding cover mating passage is in continuity with the connector insulating core mating space, allowing the second major signal terminal mating structure to be mated via the second major metal shielding cover mating passage on the major mating side, and the second major metal shielding cover joining passage is in continuity with the connector insulating core joining space, allowing the second major signal terminal joining structure to be joined via the second major metal shielding cover joining passage on the major joining side, wherein the second major metal shielding cover mating shielding structure extends on the major non-mating side, and the second major metal shielding cover joining shielding structure extends on the major non-joining side; and a major bridging conductive component, the major bridging conductive component comprising a first major bridging conductive component non-mating side shielding wall, the major bridging conductive component being configured in the connector insulating core, such that the first major bridging conductive component non-mating side shielding wall extends on the major non-mating side and is located between the first major terminal module and the second major terminal module, and the major bridging conductive component bridging over the first major signal terminal and the second major signal terminal, respectively joining the first major metal shielding cover and the second major metal shielding cover, allowing the first major bridging conductive component non-mating side shielding wall, the first major metal shielding cover mating shielding structure, and the second major metal shielding cover mating shielding structure to be electrically connected, providing a shielding environment for the first major signal terminal mating structure and the second major signal terminal mating structure, and allowing the first major metal shielding cover joining shielding structure and the second major metal shielding cover joining shielding structure to be electrically connected, providing a shielding environment for the first major signal terminal joining structure and the second major signal terminal joining structure.

Preferably, the board-end connector said above, wherein the first major terminal module and the second major terminal module are substantially the same; the connector insulating core comprises a first major terminal module core configuration structure and a second major terminal module core configuration structure, and the first major terminal module core configuration structure is configured to the first major terminal module, and the second major terminal module core configuration structure is configured to the second major terminal module.

Preferably, the board-end connector said above, further comprising: a third major terminal module, the third major terminal module comprising a third major signal terminal, a third major metal shielding cover, and a third major signal terminal insulating core, and the third major signal terminal comprises a third major signal terminal mating structure and a third major signal terminal joining structure, and the third major metal shielding cover comprises a third major metal shielding cover mating shielding structure, a third major metal shielding cover joining shielding structure, a third major metal shielding cover mating passage, and a third major metal shielding cover joining passage, and the third major signal terminal insulating core is mated with the third major signal terminal, and the third major terminal module is configured in the connector insulating core, positioning the third major signal terminal mating structure within the connector insulating core mating space, and positioning the third major signal terminal joining structure within the connector insulating core joining space, and the third major metal shielding cover is mated with the third major signal terminal insulating core, so that the third major metal shielding cover mating passage is in continuity with the connector insulating core mating space, allowing the third major signal terminal mating structure to mate via the third major metal shielding cover mating passage on the major mating side, and the third major metal shielding cover joining passage is in continuity with the connector insulating core joining space, allowing the third major signal terminal joining structure to join via the third major metal shielding cover joining passage on the major joining side, wherein the third major metal shielding cover mating shielding structure extends on the major non-mating side, and the third major metal shielding cover joining shielding structure extends on the major non-joining side; wherein the major bridging conductive component further comprises a second major bridging conductive component non-mating side shielding wall, and the second major bridging conductive component non-mating side shielding wall extends on the major non-mating side and is located between the second major terminal module and the third major terminal module. The major bridging conductive component also bridges across the second major signal terminal and the third major signal terminal, respectively joining the second major metal shielding cover and the third major metal shielding cover, thereby allowing the second major bridging conductive component non-mating side shielding wall, the second major metal shielding cover mating shielding structure, and the third major metal shielding cover mating shielding structure to be electrically connected, providing a shielding environment for the second major signal terminal mating structure and the third major signal terminal mating structure.

Preferably, the board-end connector said above, wherein the major bridging conductive component further comprises a major bridging conductive component mating side shielding wall and a major bridging conductive component non-mating side abutting wall; wherein the major bridging conductive component mating side shielding wall extends on the major mating side, providing a shielding environment for the first major signal terminal mating structure and the second major signal terminal mating structure; and the major bridging conductive component non-mating side abutting wall extends on the major non-mating side, respectively abutting the first major metal shielding cover and the second major metal shielding cover.

Preferably, the board-end connector said above, wherein the first major bridging conductive component non-mating side shielding wall is a bent type wall, allowing the first major bridging conductive component non-mating side shielding wall to elastically abut the first major metal shielding cover and the second major metal shielding cover, respectively.

Preferably, the board-end connector said above, wherein the first major bridging conductive component non-mating side shielding wall is a shear type wall, allowing the first major bridging conductive component non-mating side shielding wall to lock the first major metal shielding cover and the second major metal shielding cover.

Preferably, the board-end connector said above, wherein the connector insulating core further comprises a minor mating side, a minor non-mating side, a minor joining side, and a minor non-joining side, wherein the minor non-mating side and the minor mating side are substantially different, and the minor non-joining side and the minor joining side are substantially different; and the board-end connector further comprises: a first minor terminal module, and the first minor terminal module comprises a first minor signal terminal, a first minor metal shielding cover, and a first minor signal terminal insulating core, and the first minor signal terminal comprises a first minor signal terminal mating structure and a first minor signal terminal joining structure, and the first minor metal shielding cover comprises a first minor metal shielding cover mating shielding structure, a first minor metal shielding cover joining shielding structure, a first minor metal shielding cover mating passage, and a first major metal shielding cover joining passage, and the first minor signal terminal insulating core is mated with the first minor signal terminal, and the first minor terminal module is configured in the connector insulating core, so that the first minor signal terminal mating structure is located in the connector insulating core mating space and the first minor signal terminal joining structure is located in the connector insulating core joining space, and the first minor metal shielding cover is mated with the first minor signal terminal insulating core, so that the first minor metal shielding cover mating passage is in continuity with the connector insulating core mating space, allowing the first minor signal terminal mating structure to provide mating via the first minor metal shielding cover mating passage on the minor mating side, allowing the first major metal shielding cover joining passage to be in continuity with the connector insulating core joining space, allowing the first minor signal terminal joining structure to provide joining via the first major metal shielding cover joining passage on the minor joining side, wherein the first minor metal shielding cover mating shielding structure extends on the minor non-mating side, and the first minor metal shielding cover joining shielding structure extends on the minor non-joining side; a second minor terminal module, and the second minor terminal module comprises a second minor signal terminal, a second minor metal shielding cover, and a second minor signal terminal insulating core, and the second minor signal terminal comprises a second minor signal terminal mating structure and a second minor signal terminal joining structure, and the second minor metal shielding cover comprises a second minor metal shielding cover mating shielding structure, a second minor metal shielding cover joining shielding structure, a second minor metal shielding cover mating passage, and a second minor metal shielding cover joining passage, and the second minor signal terminal insulating core is mated with the second minor signal terminal, and the second minor terminal module is configured in the connector insulating core, so that the second minor signal terminal mating structure is located in the connector insulating core mating space and the second minor signal terminal joining structure is located in the connector insulating core joining space, and the second minor metal shielding cover is mated with the second minor signal terminal insulating core, so that the second minor metal shielding cover mating passage is in continuity with the connector insulating core mating space, allowing the second minor signal terminal mating structure to provide mating via the second minor metal shielding cover mating passage on the second mating side, allowing the second minor metal shielding cover joining passage to be in continuity with the connector insulating core joining space, allowing the second minor signal terminal joining structure to provide joining via the second minor metal shielding cover joining passage on the second joining side, wherein the second minor metal shielding cover mating shielding structure extends on the second non-mating side, and the second minor metal shielding cover joining shielding structure extends on the second non-joining side; and a minor bridging conductive component, and the minor bridging conductive component comprises a minor bridging conductive component non-mating side shielding wall, and the minor bridging conductive component is configured in the connector insulating core, so that the minor bridging conductive component non-mating side shielding wall extends on the minor non-mating side, and is positioned between the first minor terminal module and the second minor terminal module, and further so that the minor bridging conductive component bridges across the first minor signal terminal and the second minor signal terminal, and respectively joins the first minor metal shielding cover and the second minor metal shielding cover, allowing the minor bridging conductive component non-mating side shielding wall, the first minor metal shielding cover mating shielding structure, and the second minor metal shielding cover mating shielding structure to be electrically connected, respectively providing a shielding environment for the first minor signal terminal mating structure and the second minor signal terminal mating structure, allowing the first minor metal shielding cover joining shielding structure and the second minor metal shielding cover joining shielding structure to be electrically connected, providing a shielding environment for the first minor signal terminal joining structure and the second minor signal terminal joining structure.

Preferably, the board-end connector said above, wherein the first minor metal shielding cover extension shielding structure is located between the first major signal terminal and the first minor signal terminal to provide shielding, and the second minor metal shielding cover extension shielding structure is located between the second major signal terminal and the second minor signal terminal to provide shielding.

Compared to the prior art, the present application provides a connector assembly and board-end connector thereof, wherein the board-end connector comprises multiple terminal modules, each of which comprises a signal terminal and a metal shielding cover. The metal shielding cover provides a shielding environment for the signal terminal to reduce the level of crosstalk interference when the signal terminal transmits high-speed signals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the connector assembly in an embodiment of the present application.

FIG. 2 is a three-dimensional schematic view of the connector assembly in an embodiment of the present application.

FIG. 3 is a three-dimensional schematic view of the connector assembly in an embodiment of the present application.

FIG. 4 is a three-dimensional schematic view of the connector insulating core in an embodiment of the present application.

FIG. 5 is a three-dimensional schematic view of the connector insulating core and terminal module in an embodiment of the present application.

FIG. 6 is a three-dimensional schematic view of the connector insulating core and terminal module in an embodiment of the present application.

FIG. 7 is a three-dimensional schematic view of the terminal module in an embodiment of the present application.

FIG. 8 is a three-dimensional schematic view of the terminal module in an embodiment of the present application.

FIG. 9 is a three-dimensional schematic view of a partial component of the board-end connector in an embodiment of the present application from a first viewing angle.

FIG. 10 is a three-dimensional schematic view of a partial component of the board-end connector in an embodiment of the present application from a second viewing angle.

FIG. 11 is a three-dimensional schematic view of a partial component of the board-end connector in an embodiment of the present application from a third viewing angle.

FIG. 12 is a three-dimensional schematic view of a partial component of the board-end connector in an embodiment of the present application.

FIG. 13 is a three-dimensional schematic view of the bridging conductive component in an embodiment of the present application.

FIG. 14 is a three-dimensional schematic view of the board-end connector in an embodiment of the present application.

FIG. 15 is a three-dimensional schematic view of the board-end connector in an embodiment of the present application.

FIG. 16 is a three-dimensional schematic view of a partial component of the board-end connector in an embodiment of the present application.

FIG. 17 is a three-dimensional schematic view of a partial component of the board-end connector in an embodiment of the present application.

FIG. 18 is a three-dimensional schematic view of a partial component of the board-end connector in an embodiment of the present application.

FIG. 19 is a three-dimensional schematic view of a partial component of the board-end connector in an embodiment of the present application.

FIG. 20 is a three-dimensional schematic view of a partial component of the board-end connector in an embodiment of the present application.

FIG. 21 is a three-dimensional schematic view of a partial component of the board-end connector in an embodiment of the present application.

FIG. 22 is a three-dimensional schematic view of a partial component of the board-end connector in an embodiment of the present application.

FIG. 23 is a three-dimensional schematic view of the bridging conductive component in an embodiment of the present application from a first viewing angle.

FIG. 24 is a three-dimensional schematic view of the bridging conductive component in an embodiment of the present application from a second viewing angle.

FIG. 25 is a three-dimensional schematic view of the bridging conductive component in an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides a connector assembly and board-end connector thereof, wherein the board-end connector comprises a metal shielding cover capable of providing a shielding environment to reduce the degree of crosstalk interference affecting the signal terminals of the board-end connector when transmitting high-speed signals.

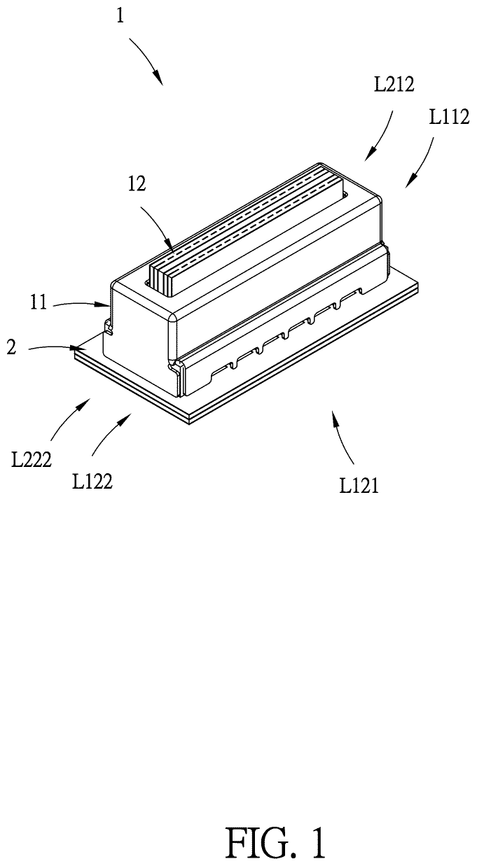

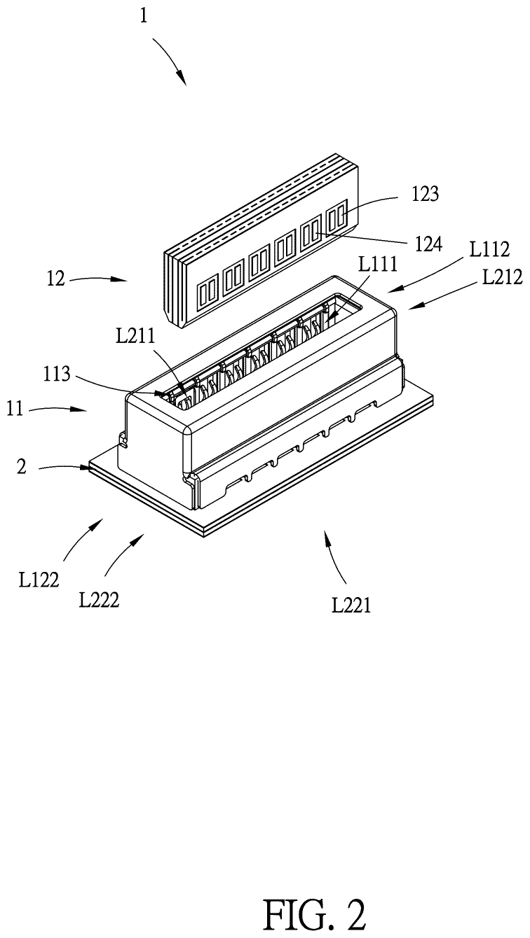

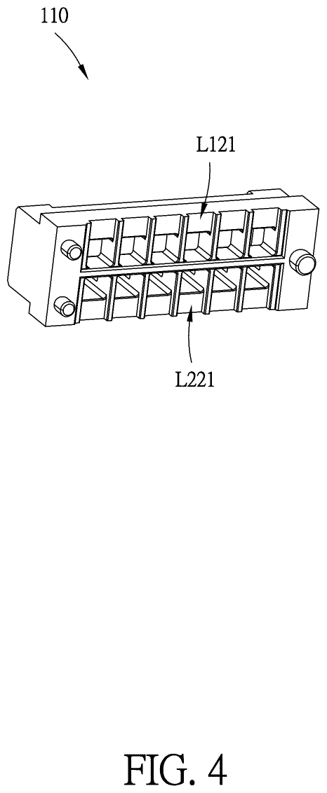

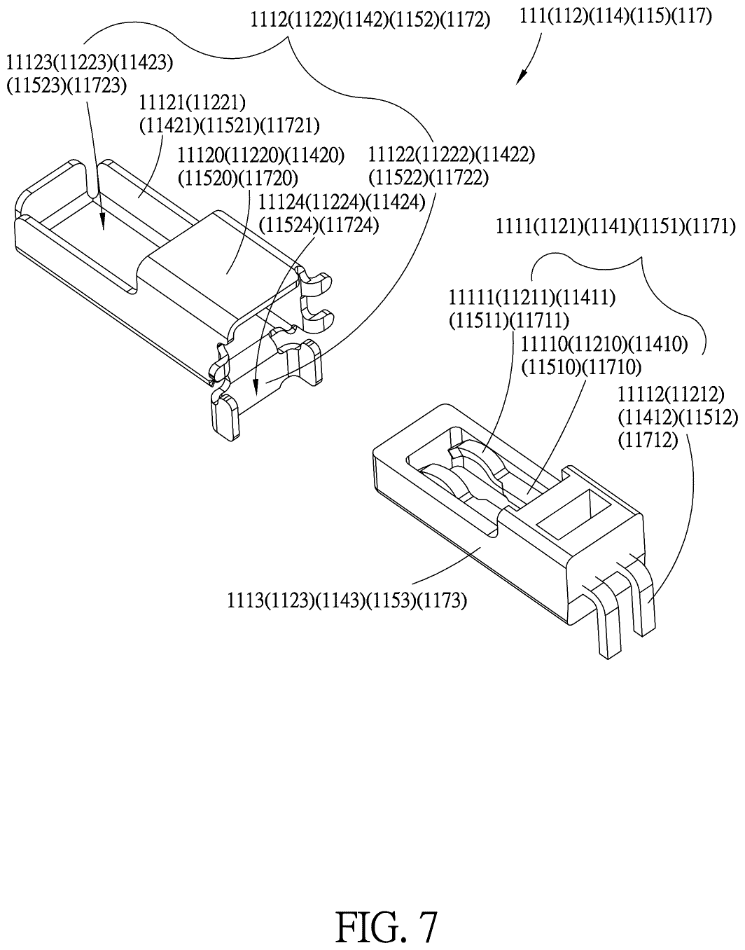

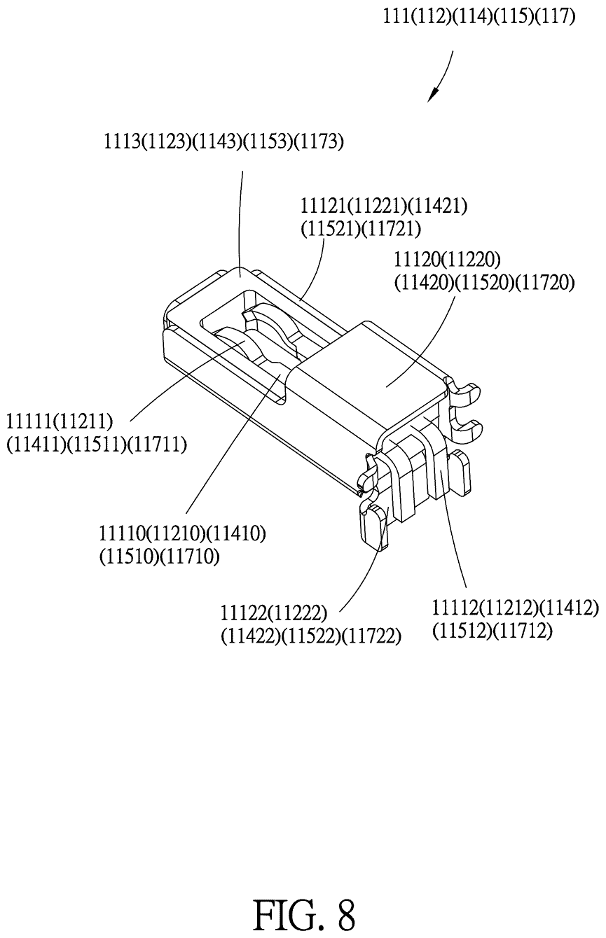

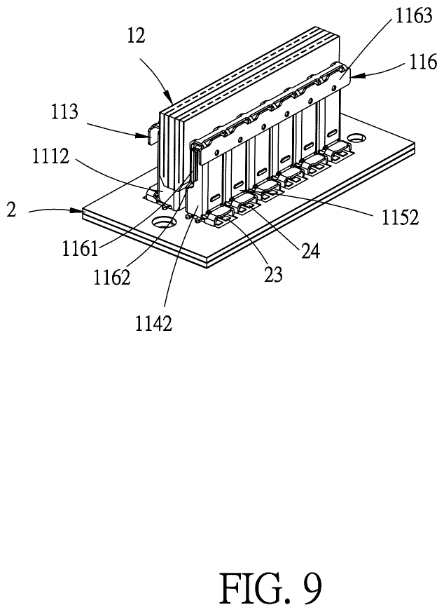

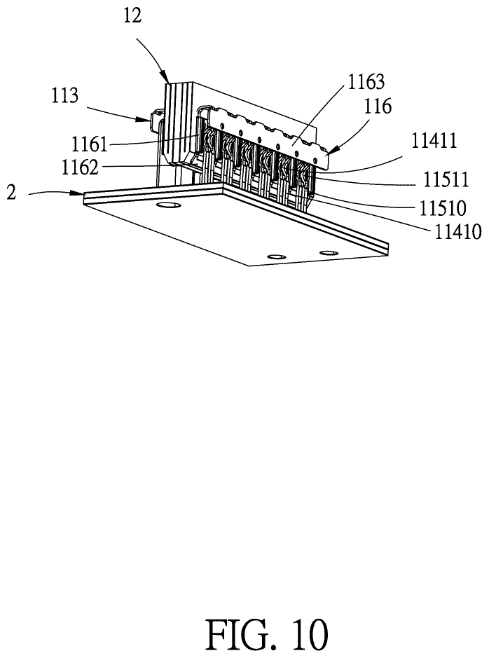

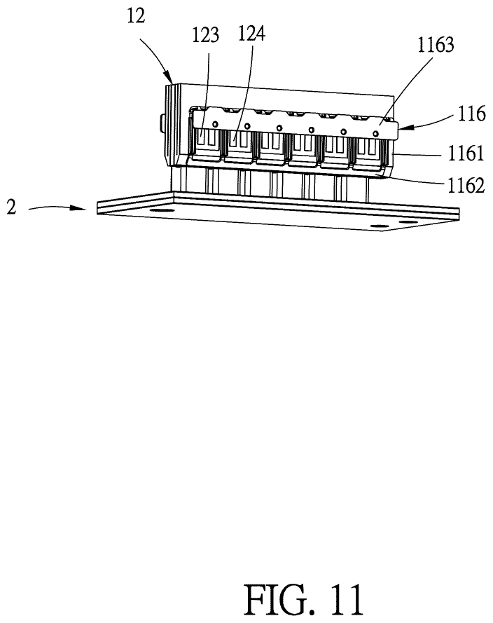

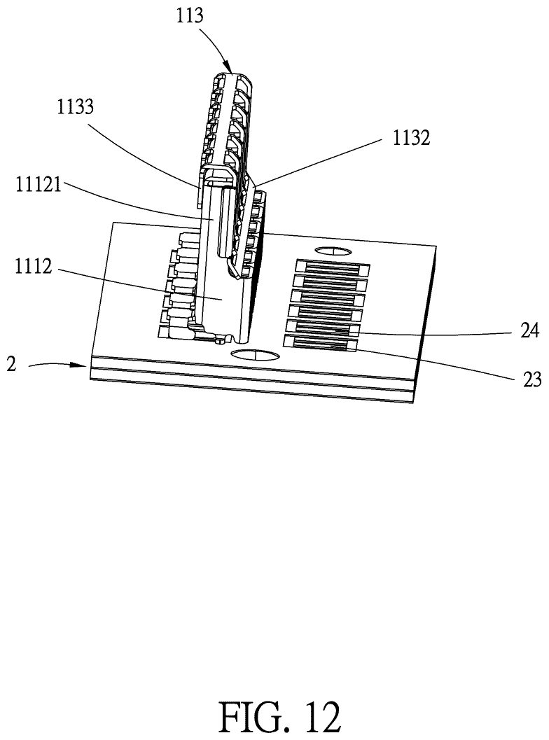

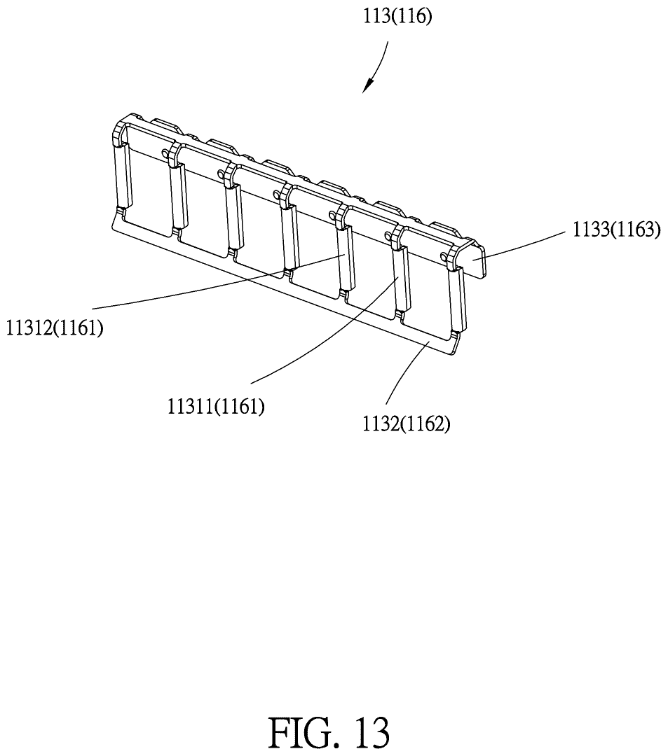

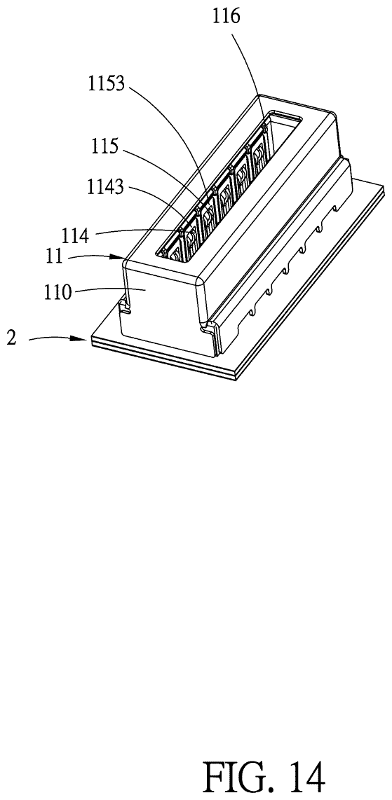

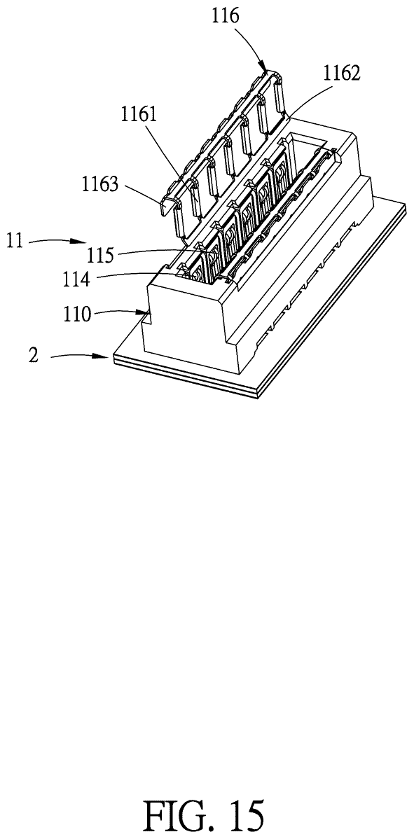

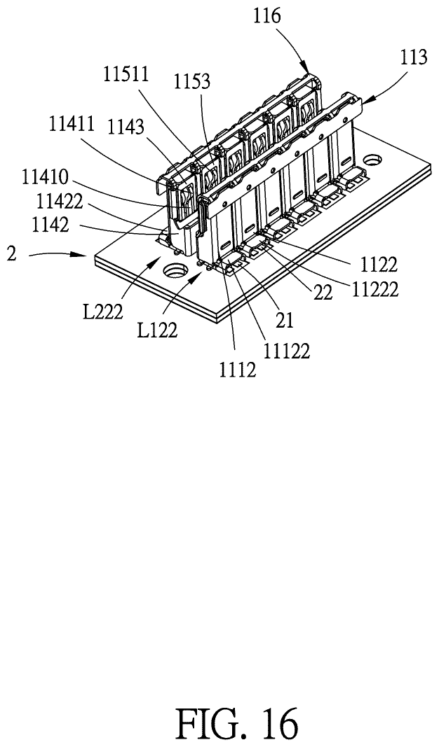

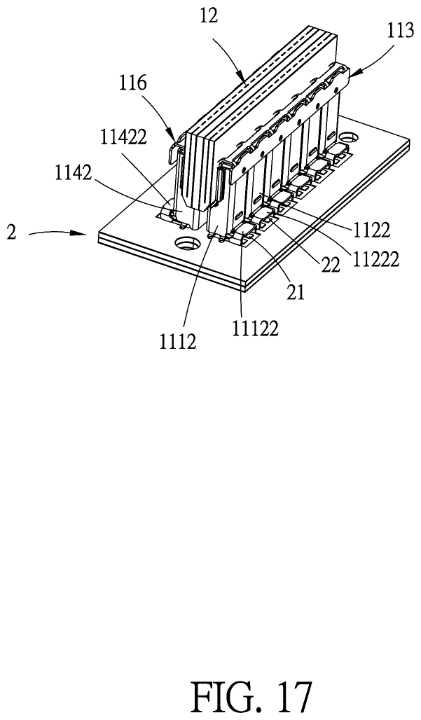

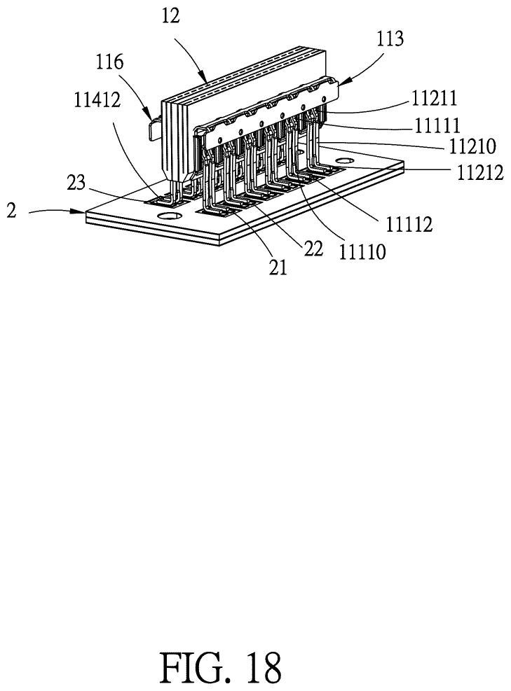

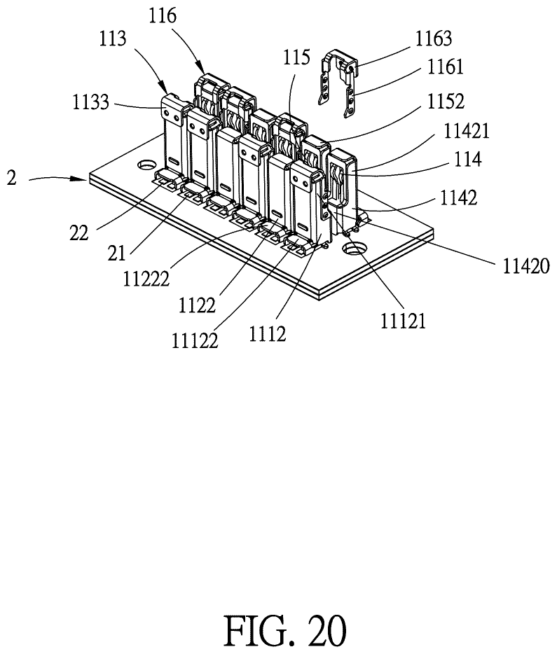

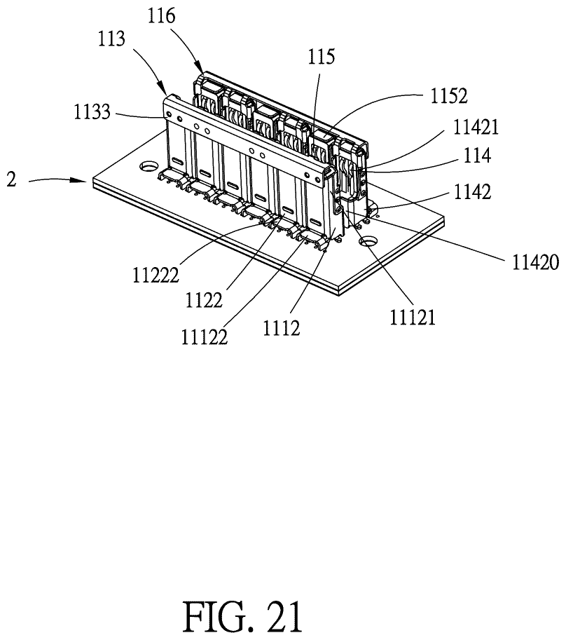

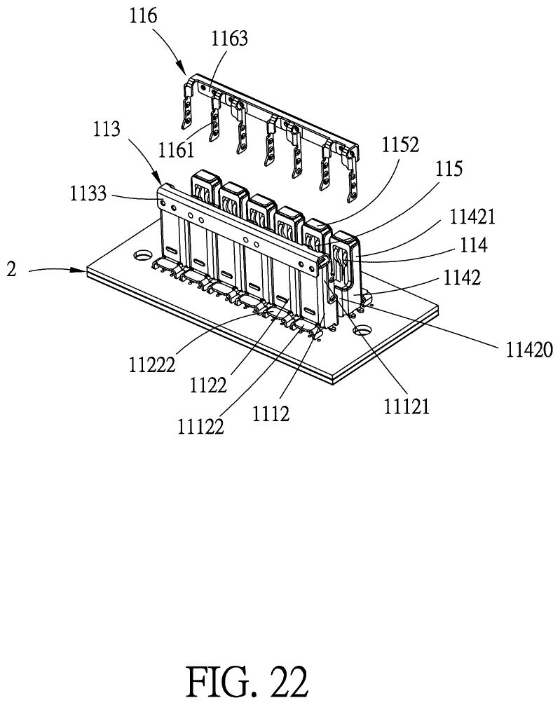

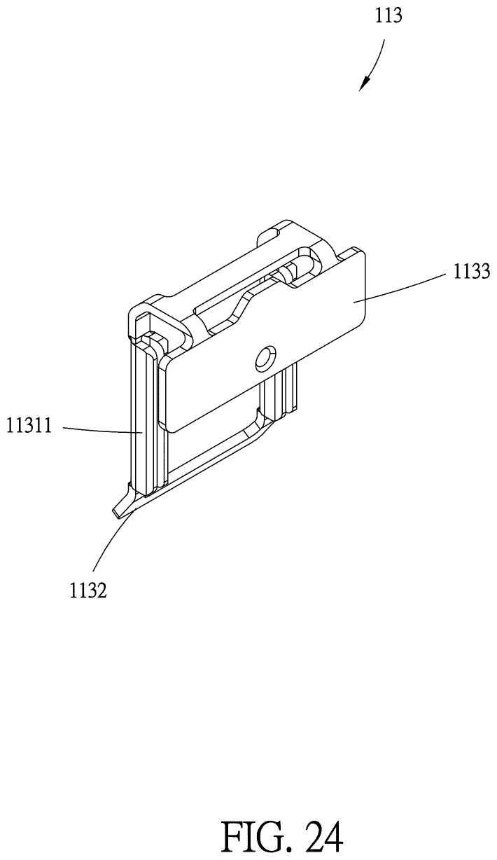

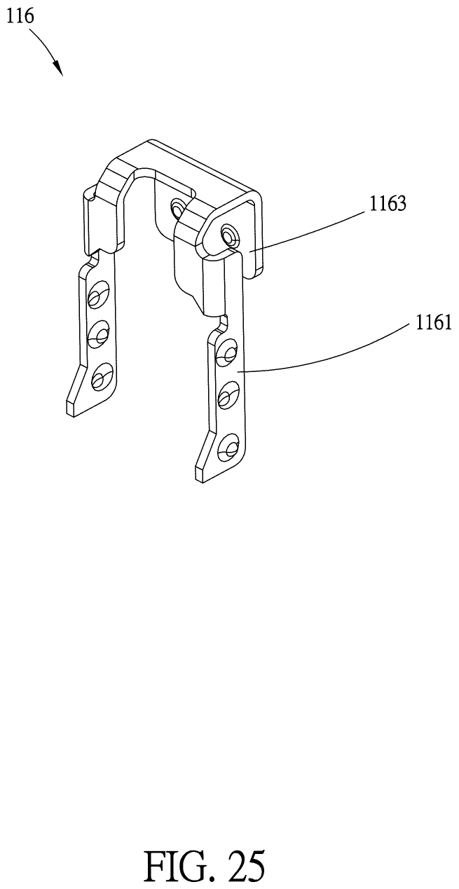

For a detailed description of the embodiments disclosed in the present application, please refer to FIGS. 1 to 25.

In the embodiments shown in FIGS. 1 to 25, a connector assembly 1 is disclosed, wherein the connector assembly 1 is equipped with a circuit board material 2. The circuit board material 2 may be, for example, a circuit board or a flexible circuit board and comprises a first major circuit board material signal terminal joining circuit 21, a second major circuit board material signal terminal joining circuit 22, a first minor circuit board material signal terminal joining circuit 23, and a second minor circuit board material signal terminal joining circuit 24. The connector assembly 1 comprises: a board-end connector 11 and a mating component 12. The mating component 12 comprises a first major mating component signal terminal mating circuit 121, a second major mating component signal terminal mating circuit 122, a first minor mating component signal terminal mating circuit 123, and a second minor mating component signal terminal mating circuit 124.

The board-end connector 11 comprises: a connector insulating core 110, a first major terminal module 111, a second major terminal module 112, and a major bridging conductive component 113. The connector insulating core 110 comprises a major mating side L111, a major non-mating side L112, a major joining side L121, a major non-joining side L122, a first minor mating side L211, a first minor non-mating side L212, a first minor joining side L221, a first minor non-joining side L222, a connector insulating core mating space S1, and a connector insulating core joining space S2. The major non-mating side L112 and the major mating side L111 are substantially different, and the major non-joining side L122 and the major joining side L121 are substantially different. Additionally, the minor non-mating side L212 and the minor mating side L211 are substantially different, and the minor non-joining side L222 and the minor joining side L221 are substantially different.

The first major terminal module 111 comprises a first major signal terminal 1111, a first major metal shielding cover 1112, and a first major signal terminal insulating core 1113. The first major signal terminal 1111 comprises a first major signal terminal extension structure 11110, a first major signal terminal mating structure 11111, and a first major signal terminal joining structure 11112. The first major signal terminal extension structure 11110 is respectively connected to the first major signal terminal mating structure 11111 and the first major signal terminal joining structure 11112. The first major metal shielding cover 1112 comprises a first major metal shielding cover extension shielding structure 11120, a first major metal shielding cover mating shielding structure 11121, a first major metal shielding cover joining shielding structure 11122, a first major metal shielding cover mating passage 11123, and a first major metal shielding cover joining passage 11124.

It should be noted that the first major signal terminal insulating core 1113 is mated with the first major signal terminal 1111. Preferably, the first major signal terminal insulating core 1113 is mated with the first major signal terminal extension structure 11110, and the first major terminal module 111 is configured in the connector insulating core 110, such that the first major signal terminal mating structure 11111 is located in the connector insulating core mating space S1 and the first major signal terminal joining structure 11112 is located in the connector insulating core joining space S2. The first major metal shielding cover 1112 is mated with the first major signal terminal insulating core 1113, such that the first major metal shielding cover mating passage 11123 is in continuity with the connector insulating core mating space S1, allowing the first major signal terminal mating structure 11111 to mate via the first major metal shielding cover mating passage 11123 on the major mating side L111, and allowing the first major metal shielding cover joining passage 11124 to be in continuity with the connector insulating core joining space S2, so that the first major signal terminal joining structure 11112 can join via the first major metal shielding cover joining passage 11124 on the major joining side L121, wherein the first major metal shielding cover mating shielding structure 11121 extends on the major non-mating side L112, and the first major metal shielding cover joining shielding structure 11122 extends on the major non-joining side L122. Preferably, the first major metal shielding cover extension shielding structure 11120 extends on the major mating side L111 to provide a shielding environment for the first major signal terminal extension structure 11110.

The second major terminal module 112 comprises a second major signal terminal 1121, a second major metal shielding cover 1122, and a second major signal terminal insulating core 1123. The second major signal terminal 1121 comprises a second major signal terminal extension structure 11210, a second major signal terminal mating structure 11211, and a second major signal terminal joining structure 11212. The second major signal terminal extension structure 11210 connects the second major signal terminal mating structure 11211 and the second major signal terminal joining structure 11212. The second major metal shielding cover 1122 comprises a second major metal shielding cover mating shielding structure 11221, a second major metal shielding cover joining shielding structure 11222, a second major metal shielding cover mating passage 11223, and a second major metal shielding cover joining passage 11224.

It should be noted that the second major signal terminal insulating core 1123 is mated with the second major signal terminal 1121. Preferably, the second major signal terminal insulating core 1123 is mated with the second major signal terminal extension structure 11210, and the second major terminal module 112 is configured in the connector insulating core 110, such that the second major signal terminal mating structure 11211 is located in the connector insulating core mating space S1 and the second major signal terminal joining structure 11212 is located in the connector insulating core joining space S2. The second major metal shielding cover 1122 is mated with the second major signal terminal insulating core 1123, such that the second major metal shielding cover mating passage 11223 is in continuity with the connector insulating core mating space S1, allowing the second major signal terminal mating structure 11211 to mate via the second major metal shielding cover mating passage 11223 on the major mating side L111, and allowing the second major metal shielding cover joining passage 11224 to be in continuity with the connector insulating core joining space S2, so that the second major signal terminal joining structure 11212 can join via the second major metal shielding cover joining passage 11224 on the major joining side L121, wherein the second major metal shielding cover mating shielding structure 11221 extends on the major non-mating side L112, and the second major metal shielding cover joining shielding structure 11222 extends on the major non-joining side L122. Preferably, the second major metal shielding cover extension shielding structure 11220 extends on the major mating side L111 to provide a shielding environment for the second major signal terminal extension structure 11210.

The major bridging conductive component 113 comprises a first major bridging conductive component non-mating side shielding wall 11311, a major bridging conductive component mating side shielding wall 1132, and a major bridging conductive component non-mating side abutting wall 1133. The major bridging conductive component 113 is configured in the connector insulating core 110, such that the major bridging conductive component mating side shielding wall 1132 respectively provides a shielding environment for the first major signal terminal mating structure 11111 and the second major signal terminal mating structure 11211, thereby reducing the degree of crosstalk interference during high-speed signal transmission between the first major signal terminal mating structure 11111 and the second major signal terminal mating structure 11211. Furthermore, the first major bridging conductive component non-mating side shielding wall 11311, the first major metal shielding cover mating shielding structure 11121, and the second major metal shielding cover mating shielding structure 11221 are electrically connected to provide transmission of shielded signals, respectively providing shielding environments for the first major signal terminal mating structure 11111 and the second major signal terminal mating structure 11211, thereby reducing the degree of crosstalk interference during high-speed signal transmission. Additionally, the first major metal shielding cover joining shielding structure 11122 and the second major metal shielding cover joining shielding structure 11222 are electrically connected to provide transmission of shielded signals, respectively providing shielding environments for the first major signal terminal joining structure 11112 and the second major signal terminal joining structure 11212, thereby reducing the degree of crosstalk interference during high-speed signal transmission.

It should be noted that, in the above embodiment, the major bridging conductive component 113 spans across the first major signal terminal 1111 and the second major signal terminal 1121, respectively, and respectively joins with the first major metal shielding cover 1112 and the second major metal shielding cover 1122 to provide transmission of a shielding signal. The first major bridging conductive component non-mating side shielding wall 11311 is positioned between the first major terminal module 111 and the second major terminal module 112, respectively joining the first major metal shielding cover 1112 and the second major metal shielding cover 1122 to provide transmission of a shielding signal. The first major bridging conductive component non-mating side shielding wall 11311 extends along the major non-mating side L112, while the major bridging conductive component mating side shielding wall 1132 extends along the major mating side L111. The major bridging conductive component non-mating side abutting wall 1133 extends along the major non-mating side L112, and the major bridging conductive component non-mating side abutting wall 1133 optionally features a protruding structure, allowing it to abut the first major metal shielding cover 1112 and the second major metal shielding cover 1122 to provide transmission of a shielding signal.

It should be noted that, in the present application, the first major terminal module 111 and the second major terminal module 112 are designed to be modular, such that the size specifications of the first major terminal module 111 and the second major terminal module 112 are essentially the same. Thus, the first major terminal module 111 and the second major terminal module 112 can be manufactured using the same equipment or process, thereby reducing the manufacturing cost of the board-end connector 11.

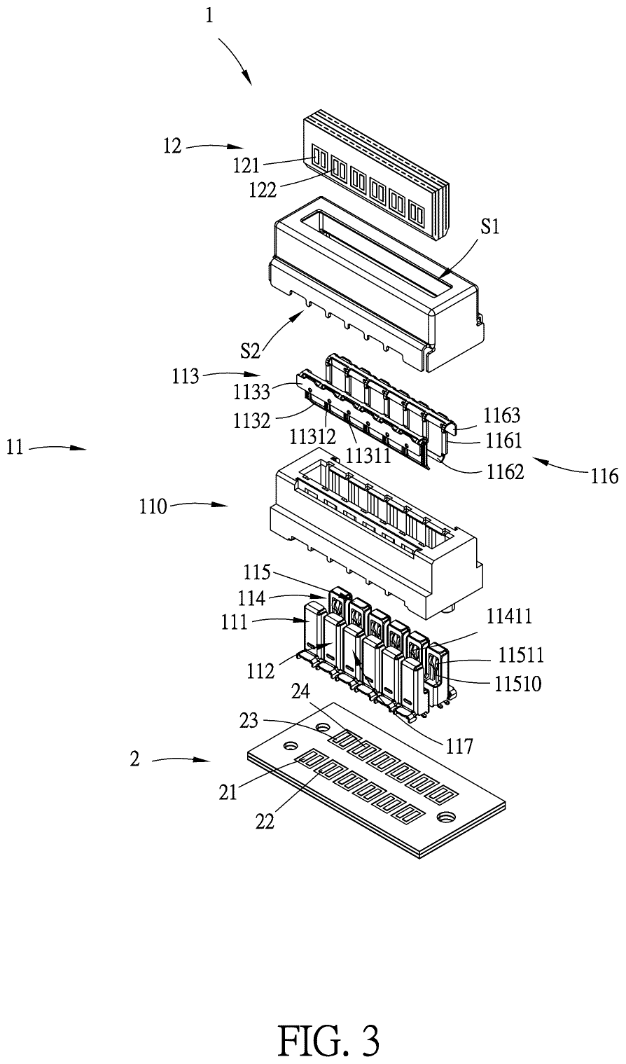

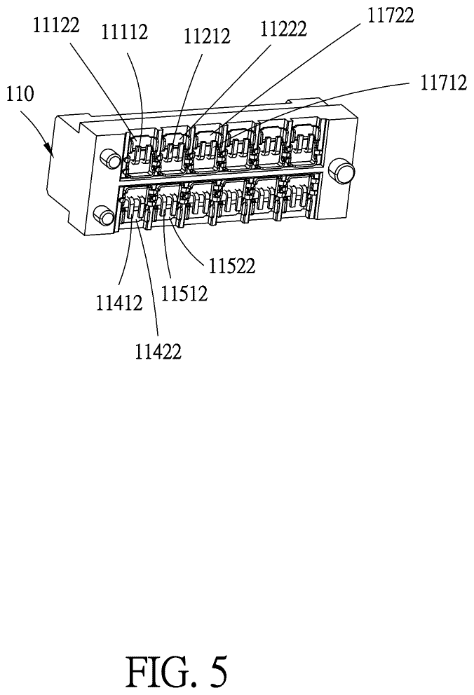

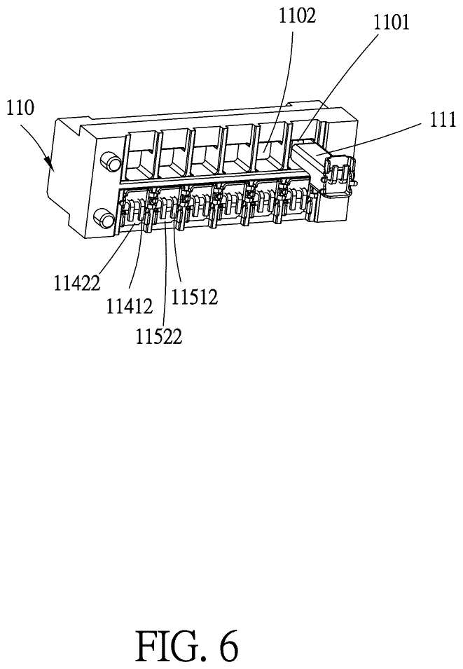

Additionally, in the embodiments shown in FIGS. 5 to 6, the connector insulating core 110 comprises a first major terminal module core configuration structure 1101 and a second major terminal module core configuration structure 1102. The first major terminal module core configuration structure 1101 and the second major terminal module core configuration structure 1102 are configuration slot structures, which allow for the respective (sequential) configuration of the first major terminal module 111 and the second major terminal module 112. It should be noted that, in the present application, the connector insulating core 110 can adjust the quantity of the first major terminal module core configuration structure 1101 and the second major terminal module core configuration structure 1102 to increase or decrease the number of configurations of the first major terminal module 111 and the second major terminal module 112, thereby ensuring that the electrical characteristics of the board-end connector 11 meet the requirements. Optionally, as shown in FIGS. 3, 13, and 23, the first major bridging conductive component non-mating side shielding wall 11311 can be a bent-type wall, allowing the first major bridging conductive component non-mating side shielding wall 11311 to elastically abut the first major metal shielding cover 1112 and the second major metal shielding cover 1122, respectively, thereby maintaining the first major bridging conductive component non-mating side shielding wall 11311 between the first major metal shielding cover 1112 and the second major metal shielding cover 1122.

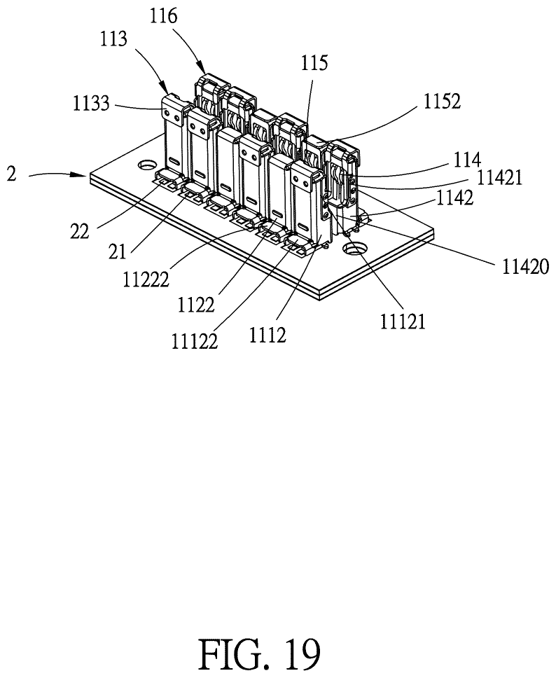

Optionally, as shown in FIGS. 19 to 22 and 25, the first major bridging conductive component non-mating side shielding wall 11311 can be a shear-type wall, allowing the first major bridging conductive component non-mating side shielding wall 11311 to be locked by the first major metal shielding cover 1112 and the second major metal shielding cover 1122 via a concave-convex structure, thereby maintaining the first major bridging conductive component non-mating side shielding wall 11311 between the first major metal shielding cover 1112 and the second major metal shielding cover 1122.

In the embodiment shown in FIGS. 3 and 7 to 8, the board-end connector 11 further comprises a third major terminal module 117. The third major terminal module 117 comprises a third major signal terminal 1171, a third major metal shielding cover 1172, and a third major signal terminal insulating core 1173. The third major signal terminal 1171 comprises a third major signal terminal mating structure 11711 and a third major signal terminal joining structure 11712. The third major metal shielding cover 1172 comprises a third major metal shielding cover mating shielding structure 11721, a third major metal shielding cover joining shielding structure 11722, a third major metal shielding cover mating passage 11723, and a third major metal shielding cover joining passage 11724.

It should be noted that the third major signal terminal insulating core 1173 is mated with the third major signal terminal 1171, and the third major terminal module 117 is configured in the connector insulating core 110, such that the third major signal terminal mating structure 11711 is positioned in the connector insulating core mating space S1 and the third major signal terminal joining structure 11712 is positioned in the connector insulating core joining space S2, respectively. The third major metal shielding cover 1172 is mated with the third major signal terminal insulating core 1173, such that the third major metal shielding cover mating passage 11723 is in continuity with the connector insulating core mating space S1, allowing the third major signal terminal mating structure 11711 to mate via the third major metal shielding cover mating passage 11723 on the major mating side L111. The third major metal shielding cover joining passage 11724 is in continuity with the connector insulating core joining space S2, allowing the third major signal terminal joining structure 11312 to join via the third major metal shielding cover joining passage 11724 on the major joining side L121. The third major metal shielding cover mating shielding structure 11721 extends along the major non-mating side L112, while the third major metal shielding cover joining shielding structure 11722 extends along the major non-joining side L122.

Accordingly, the major bridging conductive component 113 also comprises a second major bridging conductive component non-mating side shielding wall 11312. The second major bridging conductive component non-mating side shielding wall 11312 extends from the major non-mating side L112, and is located between the second major terminal module 112 and the third major terminal module 113. The major bridging conductive component 113 further bridges over the second major signal terminal 1121 and the third major signal terminal 1131, respectively, mating with the second major metal shielding cover 1122 and the third major metal shielding cover 1132, allowing the second major bridging conductive component non-mating side shielding wall 11312, the second major metal shielding cover mating shielding structure 11221, and the third major metal shielding cover mating shielding structure 11721 to be electrically connected, providing a shielding environment for the second major signal terminal mating structure 11211 and the third major signal terminal mating structure 11711, reducing crosstalk interference when the second major signal terminal mating structure 11211 and the third major signal terminal mating structure 11711 transmits high-speed signals. Furthermore, the second major metal shielding cover joining shielding structure 11222 and the third major metal shielding cover joining shielding structure 11722 are electrically connected, providing a shielding environment for the second major signal terminal joining structure 11212 and the third major signal terminal joining structure 11712, reducing crosstalk interference when the second major signal terminal joining structure 11212 and the third major signal terminal joining structure 11712 transmits high-speed signals.

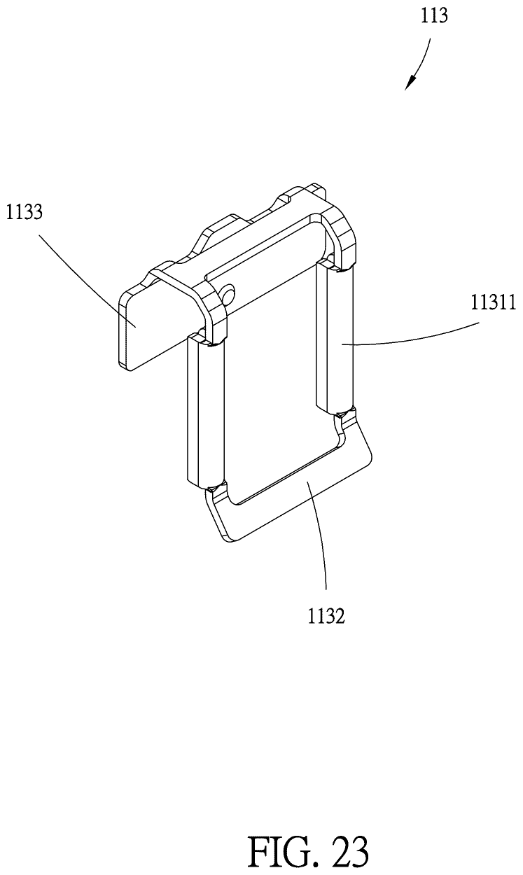

It should be noted that in the embodiments shown in FIGS. 23 to 25, the major bridging conductive component 113 omits the second major bridging conductive component non-mating side shielding wall 11312, and only comprises the first major bridging conductive component non-mating side shielding wall 11311. This allows for a reduction in the size of the major bridging conductive component 113 to meet usage requirements. Additionally, in this application, the major bridging conductive component 113 may comprise multiple first major bridging conductive component non-mating side shielding walls 11311 to accommodate the usage requirements of increased size of the major bridging conductive component 113, and is not limited to the embodiment disclosed above. The first minor terminal module 114 comprises a first minor signal terminal 1141, a first minor metal shielding cover 1142, and a first minor signal terminal insulating core 1143. The first minor signal terminal 1141 comprises a first minor signal terminal extension structure 11410, a first minor signal terminal mating structure 11411, and a first minor signal terminal joining structure 11412. The first minor signal terminal extension structure 11410 respectively connects the first minor signal terminal mating structure 11411 and the first minor signal terminal joining structure 11412. The first minor metal shielding cover 1142 comprises a first minor metal shielding cover extension shielding structure 11420, a first minor metal shielding cover mating shielding structure 11421, a first minor metal shielding cover joining shielding structure 11422, a first minor metal shielding cover mating passage 11423, and a first major metal shielding cover joining passage 11424.

It should be noted that the first minor signal terminal insulating core 1143 is mated with the first minor signal terminal 1141. Preferably, the first minor signal terminal insulating core 1143 is mated with the first minor signal terminal extension structure 11410, and the first minor terminal module 114 is configured in the connector insulating core 110, positioning the first minor signal terminal mating structure 11411 within the connector insulating core mating space S1, and positioning the first minor signal terminal joining structure 11412 within the connector insulating core joining space S2, respectively. The first minor metal shielding cover 1142 is mated with the first minor signal terminal insulating core 1143, allowing the first minor metal shielding cover mating passage 11423 to be in continuity with the connector insulating core mating space S1, enabling the first minor signal terminal mating structure 11411 to provide mating on the minor mating side L211 via the first minor metal shielding cover mating passage 11423. Additionally, the first major metal shielding cover joining passage 11424 is in continuity with the connector insulating core joining space S2, allowing the first minor signal terminal joining structure 11412 to provide joining on the minor joining side L221 via the first major metal shielding cover joining passage 11424. The first minor metal shielding cover mating shielding structure 11421 extends from the minor non-mating side L212, while the first minor metal shielding cover joining shielding structure 11422 extends from the minor non-joining side L222. Preferably, the first minor metal shielding cover extension shielding structure 11420 extends from the minor mating side L211, providing a shielding environment for the first minor signal terminal extension structure 11410.

The second minor terminal module 115 comprises a second minor signal terminal 1151, a second minor metal shielding cover 1152, and a second minor signal terminal insulating core 1153. The second minor signal terminal 1151 comprises a second minor signal terminal extension structure 11510, a second minor signal terminal mating structure 11511, and a second minor signal terminal joining structure 11512. The second minor signal terminal extension structure 11510 respectively connects the second minor signal terminal mating structure 11511 and the second minor signal terminal joining structure 11512. The second minor metal shielding cover 1152 comprises a second minor metal shielding cover extension shielding structure 11520, a second minor metal shielding cover mating shielding structure 11521, a second minor metal shielding cover joining shielding structure 11522, a second minor metal shielding cover mating passage 11523, and a second minor metal shielding cover joining passage 11524.

It should be noted that the second minor signal terminal insulating core 1153 is mated with the second minor signal terminal 1151. Preferably, the second minor signal terminal insulating core 1153 is mated with the second minor signal terminal extension structure 11510. The second minor terminal module 115 is assembled within the connector insulating core 110, such that the second minor signal terminal mating structure 11511 is located within the connector insulating core mating space S1 and the second minor signal terminal joining structure 11512 is located within the connector insulating core joining space S2. The second minor metal shielding cover 1152 is mated with the second minor signal terminal insulating core 1153, such that the second minor metal shielding cover mating passage 11523 is in continuity with the connector insulating core mating space S1, allowing the second minor signal terminal mating structure 11511 to mate via the second minor metal shielding cover mating passage 11523 on the minor mating side L211. The second minor metal shielding cover joining passage 11524 is in continuity with the connector insulating core joining space S2, allowing the second minor signal terminal joining structure 11512 to join via the second minor metal shielding cover joining passage 11524 on the minor joining side L221. The second minor metal shielding cover mating shielding structure 11521 extends on the minor non-mating side L212, and the second minor metal shielding cover joining shielding structure 11522 extends on the minor non-joining side L222. Preferably, the second minor metal shielding cover extension shielding structure 11520 extends on the minor mating side L211 to provide a shielding environment for the second minor signal terminal extension structure 11510.

The minor bridging conductive component 116 comprises the minor bridging conductive component non-mating side shielding wall 1161, the minor bridging conductive component mating side shielding wall 1162, and the minor bridging conductive component non-mating side abutting wall 1163. The minor bridging conductive component 116 is configured within the connector insulating core 110, such that the minor bridging conductive component mating side shielding wall 1162 provides a shielding environment for the first minor signal terminal mating structure 11411 and the second minor signal terminal mating structure 11511, reducing the level of crosstalk interference when the first minor signal terminal mating structure 11411 and the second minor signal terminal mating structure 11511 transmit high-speed signals. The minor bridging conductive component non-mating side shielding wall 1161, the first minor metal shielding cover mating shielding structure 11421, and the second minor metal shielding cover mating shielding structure 11521 are electrically connected to provide transmission of a shielding signal and they provide a shielding environment for the first minor signal terminal mating structure 11411 and the second minor signal terminal mating structure 11511, reducing the level of crosstalk interference when the first minor signal terminal mating structure 11411 and the second minor signal terminal mating structure 11511 transmit high-speed signals Additionally, the first minor metal shielding cover joining shielding structure 11422 and the second minor metal shielding cover joining shielding structure 11522 are electrically connected to provide transmission of a shielding signal, providing a shielding environment for the first minor signal terminal joining structure 11412 and the second minor signal terminal joining structure 11512, thereby reducing the level of crosstalk interference when the first minor signal terminal joining structure 11412 and the second minor signal terminal joining structure 11512 transmit high-speed signals.

It should be noted that in the above embodiment, the minor bridging conductive component 116 bridges over the first minor signal terminal 1141 and the second minor signal terminal 1151, and respectively joins the first minor metal shielding cover 1142 and the second minor metal shielding cover 1152 to provide a transmission of a shielding signal. The minor bridging conductive component non-mating side shielding wall 1161 is located between the first minor terminal module 114 and the second minor terminal module 115, and respectively joins the first minor metal shielding cover 1142 and the second minor metal shielding cover 1152 to provide a transmission of a shielding signal. The minor bridging conductive component non-mating side shielding wall 1161 extends on the minor non-mating side L212, and the minor bridging conductive component mating side shielding wall 1162 extends on the minor mating side L211. The minor bridging conductive component non-mating side abutting wall 1163 extends on the minor non-mating side L212, and respectively abuts the first minor metal shielding cover 1142 and the second minor metal shielding cover 1152 to provide a transmission of a shielding signal.

Additionally, the first minor metal shielding cover extension shielding structure 11420 is located between the first major signal terminal 1111 and the first minor signal terminal 1141 to provide shielding, and the second minor metal shielding cover extension shielding structure 11520 is located between the second major signal terminal 1121 and the second minor signal terminal 1151 to provide shielding.

In the embodiments shown in FIGS. 1 to 3 and FIGS. 14 to 15, the board-end connector 11 is capable of being joined with the circuit board 2, such that the first major signal terminal joining structure 11112 can be joined with the first major circuit board signal terminal mating circuit 21 on the major mating side L121 and the second major signal terminal joining structure 11212 can be joined with the second major circuit board signal terminal mating circuit 22 on the major mating side L121 to transmit electrical signals. Additionally, the first minor signal terminal joining structure 11412 can be joined with the first minor circuit board signal terminal mating circuit 23 on the minor mating side L221 and the second minor signal terminal joining structure 11512 can be joined with the second minor circuit board signal terminal mating circuit 24 on the minor mating side L221 to transmit electrical signals.

Furthermore, the mating component 12, such as a PCIE card, can mate with the board-end connector 11, allowing the first major signal terminal mating structure 11111 to mate with the first major mating component signal terminal mating circuit 121 on the major mating side L111 and allowing the second major signal terminal mating structure 11211 to mate with the second major mating component signal terminal mating circuit 122 on the major mating side L111 to transmit electrical signals. Additionally, the first minor signal terminal mating structure 11411 can mate with the first minor mating component signal terminal mating circuit 123 on the minor mating side L211, and the second minor signal terminal mating structure 11511 can mate with the second minor mating component signal terminal mating circuit 124 on the minor mating side L211 to transmit electrical signals.

It should be noted that the connector assembly and board-end connector thereof in this application can omit certain components and are not limited to the above embodiments.

In conclusion, this application provides a connector assembly and board-end connector thereof, wherein the board-end connector comprises multiple terminal modules, each of which comprises a signal terminal and a metal shielding cover. The metal shielding cover provides a shielding environment for the signal terminal to reduce the degree of crosstalk interference when the signal terminal transmits high-speed signals.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A board-end connector, the board-end connector comprising:
a connector insulating core, the connector insulating core comprising a major mating side, a major non-mating side, a major joining side, a major non-joining side, a connector insulating core mating space, and a connector insulating core joining space, wherein the major non-mating side and the major mating side are substantially different, and the major non-joining side and the major joining side are substantially different;
a first major terminal module, the first major terminal module comprising a first major signal terminal, a first major metal shielding cover, and a first major signal terminal insulating core, the first major signal terminal comprising a first major signal terminal mating structure and a first major signal terminal joining structure, the first major metal shielding cover comprising a first major metal shielding cover mating shielding structure, a first major metal shielding cover joining shielding structure, a first major metal shielding cover mating passage, and a first major metal shielding cover joining passage, the first major signal terminal insulating core being mated with the first major signal terminal, and the first major terminal module being configured in the connector insulating core, such that the first major signal terminal mating structure is located in the connector insulating core mating space and the first major signal terminal joining structure is located in the connector insulating core joining space, the first major metal shielding cover being mated with the first major signal terminal insulating core, such that the first major metal shielding cover mating passage is in continuity with the connector insulating core mating space, allowing the first major signal terminal mating structure to be mated via the first major metal shielding cover mating passage on the major mating side, and the first major metal shielding cover joining passage is in continuity with the connector insulating core joining space, allowing the first major signal terminal joining structure to be joined via the first major metal shielding cover joining passage on the major joining side, wherein the first major metal shielding cover mating shielding structure extends on the major non-mating side, and the first major metal shielding cover joining shielding structure extends on the major non-joining side;
a second major terminal module, the second major terminal module comprising a second major signal terminal, a second major metal shielding cover, and a second major signal terminal insulating core, the second major signal terminal comprising a second major signal terminal mating structure and a second major signal terminal joining structure, the second major metal shielding cover comprising a second major metal shielding cover mating shielding structure, a second major metal shielding cover joining shielding structure, a second major metal shielding cover mating passage, and a second major metal shielding cover joining passage, the second major signal terminal insulating core being mated with the second major signal terminal, and the second major terminal module being configured in the connector insulating core, such that the second major signal terminal mating structure is located in the connector insulating core mating space and the second major signal terminal joining structure is located in the connector insulating core joining space, the second major metal shielding cover being mated with the second major signal terminal insulating core, such that the second major metal shielding cover mating passage is in continuity with the connector insulating core mating space, allowing the second major signal terminal mating structure to be mated via the second major metal shielding cover mating passage on the major mating side, and the second major metal shielding cover joining passage is in continuity with the connector insulating core joining space, allowing the second major signal terminal joining structure to be joined via the second major metal shielding cover joining passage on the major joining side, wherein the second major metal shielding cover mating shielding structure extends on the major non-mating side, and the second major metal shielding cover joining shielding structure extends on the major non-joining side; and
a major bridging conductive component, the major bridging conductive component comprising a first major bridging conductive component non-mating side shielding wall, the major bridging conductive component being configured in the connector insulating core, such that the first major bridging conductive component non-mating side shielding wall extends on the major non-mating side and is located between the first major terminal module and the second major terminal module, and the major bridging conductive component bridging over the first major signal terminal and the second major signal terminal, respectively joining the first major metal shielding cover and the second major metal shielding cover, allowing the first major bridging conductive component non-mating side shielding wall, the first major metal shielding cover mating shielding structure, and the second major metal shielding cover mating shielding structure to be electrically connected, providing a shielding environment for the first major signal terminal mating structure and the second major signal terminal mating structure, and allowing the first major metal shielding cover joining shielding structure and the second major metal shielding cover joining shielding structure to be electrically connected, providing a shielding environment for the first major signal terminal joining structure and the second major signal terminal joining structure.

2. The board-end connector of claim 1, wherein the first major terminal module and the second major terminal module are substantially the same; the connector insulating core comprises a first major terminal module core configuration structure and a second major terminal module core configuration structure, and the first major terminal module core configuration structure is configured to the first major terminal module, and the second major terminal module core configuration structure is configured to the second major terminal module.

3. The board-end connector of claim 1, further comprising:
a third major terminal module, the third major terminal module comprising a third major signal terminal, a third major metal shielding cover, and a third major signal terminal insulating core, and the third major signal terminal comprises a third major signal terminal mating structure and a third major signal terminal joining structure, and the third major metal shielding cover comprises a third major metal shielding cover mating shielding structure, a third major metal shielding cover joining shielding structure, a third major metal shielding cover mating passage, and a third major metal shielding cover joining passage, and the third major signal terminal insulating core is mated with the third major signal terminal, and the third major terminal module is configured in the connector insulating core, positioning the third major signal terminal mating structure within the connector insulating core mating space, and positioning the third major signal terminal joining structure within the connector insulating core joining space, and the third major metal shielding cover is mated with the third major signal terminal insulating core, so that the third major metal shielding cover mating passage is in continuity with the connector insulating core mating space, allowing the third major signal terminal mating structure to mate via the third major metal shielding cover mating passage on the major mating side, and the third major metal shielding cover joining passage is in continuity with the connector insulating core joining space, allowing the third major signal terminal joining structure to join via the third major metal shielding cover joining passage on the major joining side, wherein the third major metal shielding cover mating shielding structure extends on the major non-mating side, and the third major metal shielding cover joining shielding structure extends on the major non-joining side; wherein
the major bridging conductive component further comprises a second major bridging conductive component non-mating side shielding wall, and the second major bridging conductive component non-mating side shielding wall extends on the major non-mating side and is located between the second major terminal module and the third major terminal module. The major bridging conductive component also bridges across the second major signal terminal and the third major signal terminal, respectively joining the second major metal shielding cover and the third major metal shielding cover, thereby allowing the second major bridging conductive component non-mating side shielding wall, the second major metal shielding cover mating shielding structure, and the third major metal shielding cover mating shielding structure to be electrically connected, providing a shielding environment for the second major signal terminal mating structure and the third major signal terminal mating structure.

4. The board-end connector of claim 1, wherein the major bridging conductive component further comprises a major bridging conductive component mating side shielding wall and a major bridging conductive component non-mating side abutting wall; wherein the major bridging conductive component mating side shielding wall extends on the major mating side, providing a shielding environment for the first major signal terminal mating structure and the second major signal terminal mating structure; and the major bridging conductive component non-mating side abutting wall extends on the major non-mating side, respectively abutting the first major metal shielding cover and the second major metal shielding cover.

5. The board-end connector of claim 1, wherein the first major bridging conductive component non-mating side shielding wall is a bent type wall, allowing the first major bridging conductive component non-mating side shielding wall to elastically abut the first major metal shielding cover and the second major metal shielding cover, respectively.

6. The board-end connector of claim 1, wherein the first major bridging conductive component non-mating side shielding wall is a shear type wall, allowing the first major bridging conductive component non-mating side shielding wall to lock the first major metal shielding cover and the second major metal shielding cover.

7. The board-end connector of claim 1, wherein the connector insulating core further comprises a minor mating side, a minor non-mating side, a minor joining side, and a minor non-joining side, wherein the minor non-mating side and the minor mating side are substantially different, and the minor non-joining side and the minor joining side are substantially different; and the board-end connector further comprises:
a first minor terminal module, and the first minor terminal module comprises a first minor signal terminal, a first minor metal shielding cover, and a first minor signal terminal insulating core, and the first minor signal terminal comprises a first minor signal terminal mating structure and a first minor signal terminal joining structure, and the first minor metal shielding cover comprises a first minor metal shielding cover mating shielding structure, a first minor metal shielding cover joining shielding structure, a first minor metal shielding cover mating passage, and a first major metal shielding cover joining passage, and the first minor signal terminal insulating core is mated with the first minor signal terminal, and the first minor terminal module is configured in the connector insulating core, so that the first minor signal terminal mating structure is located in the connector insulating core mating space and the first minor signal terminal joining structure is located in the connector insulating core joining space, and the first minor metal shielding cover is mated with the first minor signal terminal insulating core, so that the first minor metal shielding cover mating passage is in continuity with the connector insulating core mating space, allowing the first minor signal terminal mating structure to provide mating via the first minor metal shielding cover mating passage on the minor mating side, allowing the first major metal shielding cover joining passage to be in continuity with the connector insulating core joining space, allowing the first minor signal terminal joining structure to provide joining via the first major metal shielding cover joining passage on the minor joining side, wherein the first minor metal shielding cover mating shielding structure extends on the minor non-mating side, and the first minor metal shielding cover joining shielding structure extends on the minor non-joining side;
a second minor terminal module, and the second minor terminal module comprises a second minor signal terminal, a second minor metal shielding cover, and a second minor signal terminal insulating core, and the second minor signal terminal comprises a second minor signal terminal mating structure and a second minor signal terminal joining structure, and the second minor metal shielding cover comprises a second minor metal shielding cover mating shielding structure, a second minor metal shielding cover joining shielding structure, a second minor metal shielding cover mating passage, and a second minor metal shielding cover joining passage, and the second minor signal terminal insulating core is mated with the second minor signal terminal, and the second minor terminal module is configured in the connector insulating core, so that the second minor signal terminal mating structure is located in the connector insulating core mating space and the second minor signal terminal joining structure is located in the connector insulating core joining space, and the second minor metal shielding cover is mated with the second minor signal terminal insulating core, so that the second minor metal shielding cover mating passage is in continuity with the connector insulating core mating space, allowing the second minor signal terminal mating structure to provide mating via the second minor metal shielding cover mating passage on the second mating side, allowing the second minor metal shielding cover joining passage to be in continuity with the connector insulating core joining space, allowing the second minor signal terminal joining structure to provide joining via the second minor metal shielding cover joining passage on the second joining side, wherein the second minor metal shielding cover mating shielding structure extends on the second non-mating side, and the second minor metal shielding cover joining shielding structure extends on the second non-joining side; and
a minor bridging conductive component, and the minor bridging conductive component comprises a minor bridging conductive component non-mating side shielding wall, and the minor bridging conductive component is configured in the connector insulating core, so that the minor bridging conductive component non-mating side shielding wall extends on the minor non-mating side, and is positioned between the first minor terminal module and the second minor terminal module, and further so that the minor bridging conductive component bridges across the first minor signal terminal and the second minor signal terminal, and respectively joins the first minor metal shielding cover and the second minor metal shielding cover, allowing the minor bridging conductive component non-mating side shielding wall, the first minor metal shielding cover mating shielding structure, and the second minor metal shielding cover mating shielding structure to be electrically connected, respectively providing a shielding environment for the first minor signal terminal mating structure and the second minor signal terminal mating structure, allowing the first minor metal shielding cover joining shielding structure and the second minor metal shielding cover joining shielding structure to be electrically connected, providing a shielding environment for the first minor signal terminal joining structure and the second minor signal terminal joining structure.

8. The board-end connector of claim 7, wherein the first minor metal shielding cover extension shielding structure is located between the first major signal terminal and the first minor signal terminal to provide shielding, and the second minor metal shielding cover extension shielding structure is located between the second major signal terminal and the second minor signal terminal to provide shielding.
